(19) United States
(12) Patent Application Publication
(10) Pub. No.: US 2005/0127004 A1
(43) Pub. Date: Jun. 16, 2005

(54) Filter system for removing contaminants from water and method of use

(76) Inventor: George Lutich, Palm Harbor, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 11/013,919

(22) Filed: Dec. 16, 2004

Related U.S. Application Data
(63) Continuation-in-part of application No. 09/781,865, filed on Feb. 12, 2001, now abandoned.
Application No. 09/781,865 is a continuation-in-part of application No. 09/736,637, filed on Dec. 14, 2000, now Pat. No. 6,599,428.
Application No. 09/736,637 is a continuation-in-part of application No. 09/431,942, filed on Oct. 1, 1999, now abandoned.

(51) Int. Cl. C02F 1/58

(52) U.S. Cl. 210/668; 210/683; 210/290

(57) ABSTRACT

A water filter device containing copper media for effectively treating water and the method of use are disclosed. The water filter device has an outer housing having an inlet and an outlet; and an inner filter which has an inner filter housing, an inner filter housing inlet at one end, an inner filter housing outlet at an opposing end, and one uniform region of substantially pure copper media disposed within the inner filter housing; wherein the inner filter is situated within and in fluid communication with the outer housing. The inner filter further has a region of granulated activated carbon, and a filter pad separating the two regions. The water filter device is a shower filter which removes more than 90% of the chlorine when water passes through the water filter device at a high flow rate used for showering.

### CROSS REFERENCE TO RELATED APPLICATION

This application is a continuation-in-part application of co-pending patent application Ser. No. 09/781,865, filed Feb. 12, 2001, which is a continuation-in-part application of patent application Ser. No. 09/736,637, filed Dec. 14, 2000, now U.S. Pat. No. 6,599,428, which is a continuation-in-part application of Ser. No. 09/431,942, filed Oct. 1, 1999, now abandoned. All prior patent applications are herein incorporated by reference in their entirety.

### FIELD OF INVENTION

The present invention relates to devices for purifying water. More specifically, the present invention relates to water filter devices containing substantially pure copper media for purifying water.

### BACKGROUND OF THE INVENTION

It has been found that bathing or showering with tap water entails a number of hazards. For example, the skin may absorb undesirable constituents from the water particularly because pores of the skin are enlarged during a hot shower or bath. Additionally, to the extent that such undesirable constituents are not absorbed, harsh chemicals, such as dissolved chlorine and hydrogen sulfide, are irritating to the skin itself.

In the field of treating water for commercial, industrial and residential use, numerous systems have been proposed, many of which are cost and technically effective for purposes of removal of undesirable constituents from drinking water if the flow velocity is not high and the water is not warm. However, the development of water filters, particularly those adapted for use in showerhead applications is a comparatively recent development.

In such applications, the rate and volume of water flow is typically much greater and the water is much warmer than is the case in applications in which the only objective is to provide contaminant-free drinking water. Accordingly, the prior art filtration concepts, which are workable in drinking water applications, are unsuitable in shower or bath applications and, to a considerable extent, the reverse is also true. A shower or bath intended filter which, inherently, is designed for high speed, large volume filtration of warm or hot water would not constitute an optimal system for purposes of low volume extraction of contaminants from cooler drinking water.

Therefore, there is a need for a water filter particularly suited for use in applications in which the rate and volume of water flow is typically much greater than is the case in applications in which the objective is to provide contaminant-free drinking water.

### SUMMARY OF THE INVENTION

In one embodiment, the present invention provides a water filter device containing copper media, which comprises an outer housing comprising an inlet and an outlet; and an inner filter comprising an inner filter housing, an inner filter housing inlet at one end, an inner filter housing outlet at an opposing end, and at least one uniform region of substantially pure copper media disposed within the inner filter housing; wherein the inner filter is situated within and in fluid communication with the outer housing; and the inner filter housing inlet is in fluid communication with the inlet and the inner filter housing outlet is in fluid communication with the outlet. The substantially pure copper media contains about 90% to about 100% of copper and has a particle size from about 40 to about 200 mesh and a density of from about 3.5 to about 5.0 grams per cubic centimeter.

In one preferred embodiment, the region of substantially pure copper media is disposed from the inner filter housing inlet downward, extending at least about one-half of the inner filter housing.

The water filter device further comprises a region of granulated activated carbon, having a particle size of from about 10 mesh to about 100 mesh. The water filter device can also comprise a filter pad disposed between the region of the granulated activated carbon and the at least one uniform region of substantially pure copper media. The water filter device further comprises a mesh inlet disposed at the inner filter housing inlet, and a mesh outlet disposed at the inner filter housing outlet.

In a further embodiment, the present invention provides a method of removing chlorine from water using a substantially pure copper media. The method comprises the steps of: entering water containing chlorine into the inlet of the outer housing of the water filter device; passing the water through the at least one uniform region of substantially pure copper media disposed within the inner filter; wherein the substantially pure copper media substantially removes the chlorine in the water; exiting filtered water obtained from the outlet of the outer housing for use. The water filter device removes at least about 90% of the chlorine when the water passes through the water filter device at a rate of about 2.3 gallons per minute. It has superior performance for removing chlorine in sulfated water, in comparison to existing water filter devices.

In another embodiment, the water filter device comprises an outer housing comprising an inlet and an outlet; and an inner filter which comprises (a) an inner filter housing having a first cap disposed at an upper end of the inner filter housing; a second cap disposed at a lower end of the inner filter housing; an inner filter housing inlet disposed on the first cap and in fluid communication with the inlet of the outer housing; and an inner filter housing outlet disposed on the second cap and in fluid communication with the outlet of the outer housing; (b) a region of granulated activated carbon disposed between the first and second caps, the region of granulated activated carbon being axially around a core; the core being in fluid communication with the inner filter housing outlet on the second cap; (c) an uniform region of substantially pure copper media disposed between the first and second caps, axially around the region of granulated activated carbon; (d) a filter pad disposed axially between the region of granulated activated carbon and the uniform region of substantially pure copper media; (e) an axial mesh inlet disposed around external of the uniform region of substantially pure copper media; (f) a radial space between the first and second caps, external of the axial mesh inlet; the radial space being in fluid communication with the inner filter housing inlet on the first cap; and (g) an axial mesh outlet disposes around internal of the region of granulated activated carbon.

Using this configuration, the water passes through the inner filter housing inlet; to the radial space, through the uniform region of substantially pure copper media, through the filter pad, through the region of granulated activated carbon, to the core; wherein the substantially pure copper media substantially removes the chlorine in the water.

In yet further embodiment, the water filter device comprises an outer housing comprising an inlet and an outlet; and an inner filter which comprises (a) an inner filter housing having a first cap disposed at an upper end of the inner filter housing; a second cap disposed at a lower end of the inner filter housing; an inner filter housing inlet and an inner filter housing outlet disposed on the first cap, the inner filter housing inlet being in fluid communication with the inlet of the outer housing; and the inner filter housing outlet being in fluid communication with the outlet of the outer housing; (b) an uniform region of substantially pure copper media disposed between the first and second caps, and being axially around a core; the core being in fluid communication with the inner filter housing inlet on the first cap; (c) a region of granulated activated carbon disposed between the first and second caps, and being axially around the uniform region of substantially pure copper media; (d) a filter pad disposed axially between the region of granulated activated carbon and the uniform region of substantially pure copper media; (e) an axial mesh inlet disposes around internal of the uniform region of substantially pure copper media; (f) an axial mesh outlet disposed around external of the region of granulated activated carbon; and (g) a radial space between the first and second caps, external of the axial mesh outlet; the radial space being in fluid communication with the inner filter housing outlet on the first cap.

Using this configuration, the water passes through the inner filter housing inlet; to the core, through the uniform region of substantially pure copper media, through the filter pad, through the region of granulated activated carbon, to the radial space; wherein the substantially pure copper media substantially removes the chlorine in the water.

### BRIEF DESCRIPTION OF THE DRAWING

FIG. 1 is a side plan view of one embodiment of the filter system of the present invention attached to a showerhead.

FIG. 2 is an isometric view of a filter housing of the present invention.

FIG. 3 is an exploded isometric view showing the insertion of the filter of FIG. 2 into the filter housing of FIG. 1.

FIG. 4 is a cut-away isometric view illustrating the relationship of the components of the instant filter system.

FIG. 5 is an exploded isometric view of the filter system of FIG. 4.

FIG. 6 is a cut-away isometric view illustrating an alternative embodiment of the present invention.

FIG. 7a is a cut-away isometric view of a radial flow embodiment of the present invention.

FIG. 7b is a cut-away isometric view of a radial flow embodiment of the present invention showing the flow pattern.

FIG. 8a is a cut-away isometric view of a reverse flow embodiment of the present invention.

FIG. 8b is a cut-away isometric view of a reverse flow embodiment of the present invention showing the flow pattern.

### DETAILED DESCRIPTION

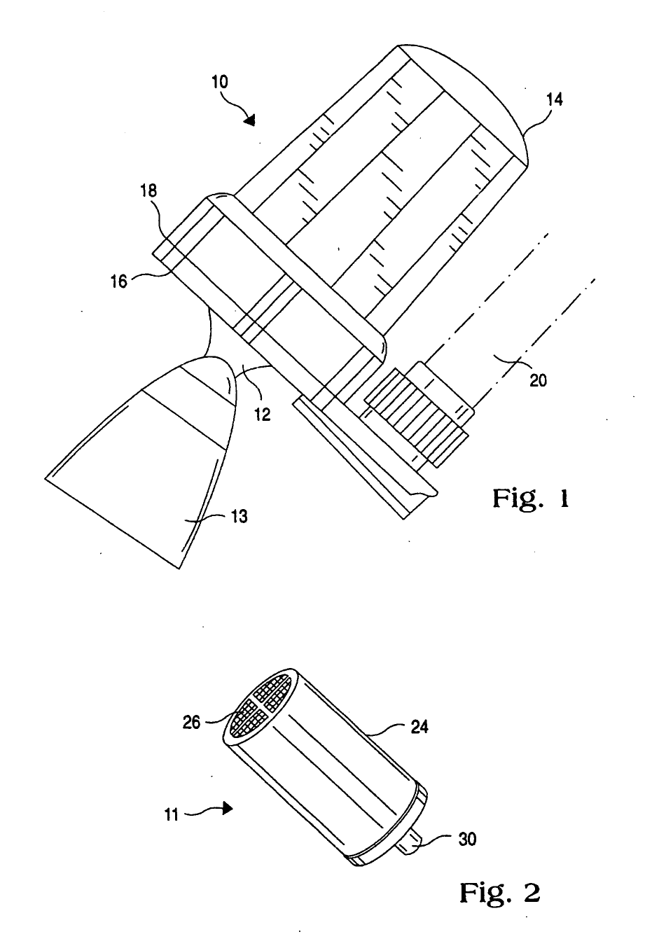

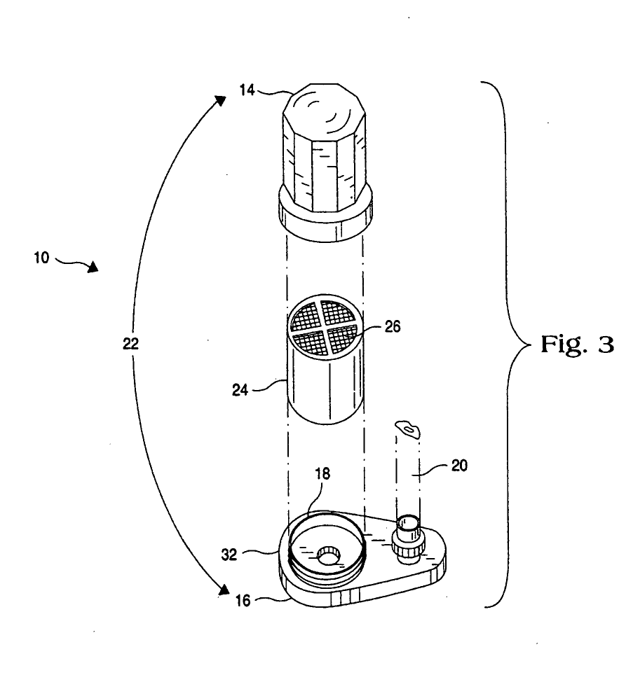

Filter 10 is shown in FIG. 1 and FIG. 3. The outer housing 22 is characterized by a proximal portion 14 and a distal portion 16, which complementarily engage each other about a circumference 18 thereof. The outer housing 22 is further characterized by an inlet 20 and outlet 12. The outlet comprises a threaded or other connector that enables the attachment of a hose or showerhead 13. The outer housing 22 is preferably constructed or injection molded of acrylonitrile-butadiene-styrene (ABS). Those skilled in the art will appreciate that any suitable temperature resistant thermoplastic material or other suitable material may be utilized for the outer housing 22.

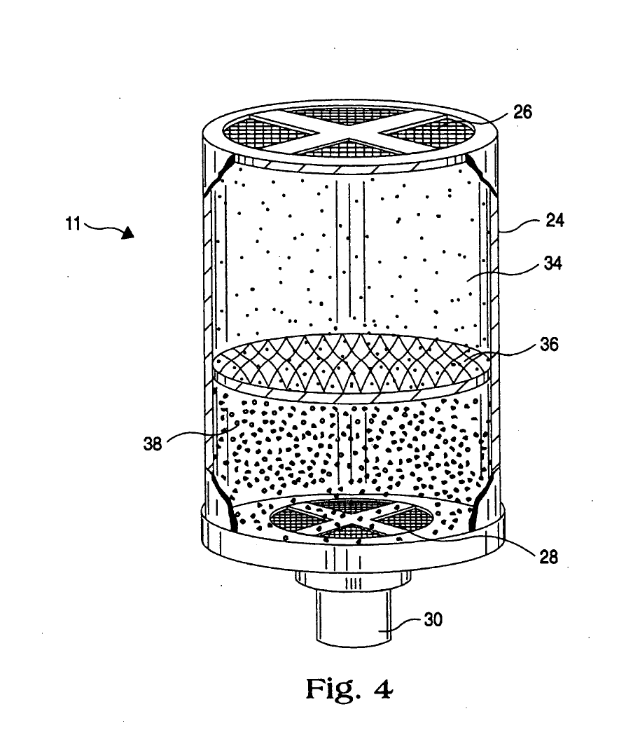

As shown in FIG. 2, secured within the outer housing 22 is an inner filter 11 including an inner filter housing 24, having a stainless steel mesh inlet 26 having a mesh value in a range of about 50 to about 100 microns. Inner filter housing 24 is also constructed of ABS or any other suitable material. A similar stainless steel mesh outlet 28 (shown in FIG. 4) is provided at filter outlet 30 of the inner filter housing 24.

The relationship between the inner filter 11 and the outer housing 22 is illustrated in FIG. 3 in which the proximal portion 14 of the outer housing 22 is shown removed. When assembled, insulation, anti-vibration padding, or structural stabilizing means or devices such as water resistant fibers, polyurethane foam, etc. may be affixed about the inner filter housing 24 within the outer housing 22. One skilled in the art will appreciate that outer housing 22 is not necessary to achieve the objects of the invention. For example, the inner filter housing 24 can be constructed of water tight plastic and serve as the outer barrier for the filter device.

As further illustrated in FIG. 3, the proximal portion 14 detachably affixes to the distal portion 16 by conventional threading or the like to provide a fluid tight seal. To improve the fluid tight seal, O-rings or other materials can be included around the circumference 18 and the filter outlet 30. Advantageously, the user can replace a spent inner filter 11 by unscrewing or otherwise detaching portions 14 and 16 and removing inner filter 11.

With reference to FIG. 4, the inner filter 11 comprises a uniform region 34 of granular copper media. In a preferred embodiment, the uniform region 34 of copper granules entirely fills the proximal or inlet region of the inner filter housing 24 and extends axially to at least about one-half of the axial length of the inner filter housing 24. Prior to use, the copper media is processed, in a manner similar to an annealing process, to remove oxides. It should be noted that the copper media can be placed at an inlet region, a center region, or at an outlet region of the inner filter housing 24 to achieve the objectives of the present invention. The amount of copper that can be used in the present invention is from about 90% to about 100% substantially pure copper with the preferred amount being 100%.

The granular copper is substantially free of contaminants. In a typical usage the particle size of the granular copper media is from about 40 mesh to about 200 mesh. In one exemplary embodiment, the particle size of the granular copper media is about 120 mesh. The density of the copper media is in the range from about 3.5 to about 5 grams/cc, while the density of one embodiment is about 4.25 grams/cc. The copper media is electrically conductive, and can range in size from a fine powder to very coarse spheres or pellets. Other contaminants in water, like lead and other heavy metals, are removed or reduced as the contaminant is bonded to the copper media. Further, it is believed that the copper oxidation/reduction reaction creates a poor environment for growth. Organisms specifically controlled include fungi, algae and bacteria.

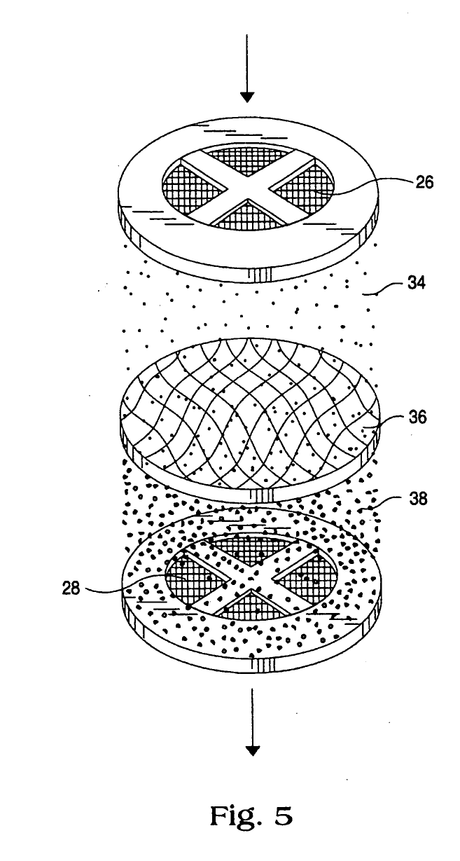

FIG. 5 shows the inner filter 11 with the inner filter housing 24 removed and indicates the direction of the flow of water through the inner filter while the filter 10 is in use. In the context of high speed, high volume fluid flow as is typical in showerhead applications, the use of copper granules having a particle size of from about 40 mesh to about 200 mesh, as a component within the filter system has been found to be more effective in removing contaminants than the use of other media known in the art. Specifically, through the use of a bed or region of copper, the removal of undesirable contaminants such as chlorine, nitrates, iron, and hydrogen sulfide may be effected. The present invention works especially well in sulfated waters where sulfates have been used as sequestering or flocculating agents.

As illustrated in FIG. 4 and FIG. 5, following the uniform region 34 of copper media is a filter pad 36. The filter pad 36 can be made of a mesh such as polymeric material such as polypropylene having a mesh size of from about 30 to about 200 microns, and in one embodiment about 100 microns. The filter pad 36 is useful as a particulate barrier, removing particles such as sediment and silt. Other materials known in the art, which can be used to make the filter pad 36 include, stainless steel mesh, copper mesh, polyester pads, Teflons®. (DuPont) pads, or molded plastic or nylon screen materials.

In the preferred embodiment, downstream of the filter pad 36 is a region of granulated activated carbon (GAC) 38 for the removal of chlorine from the water to be purified. Further, the region of GAC 38 is used for taste and odor control. The GAC has a particle size of from about 10 mesh to about 100 mesh. It should be noted that the region of GAC 38 might be placed at the inlet region, center region, or at the outlet region of the inner filter housing 24 to achieve the objects of the present invention.

GAC is also characterized by a high adsorbitivity of gases, vapors and colloidal solids. Specifically, the region of GAC 38 is useful for reducing the radon content of the water to be purified.

Following region of GAC 38 is the stainless steel mesh outlet 28. As is known by those skilled in the art, other types of non-reactive screens/filters may be used in lieu of the steel inlet and outlet meshs 26 and 28, respectively.

The present invention therefore comprises a system capable of removing organic and inorganic contaminants regardless of form (liquid, solid or gas). Contaminants such as colloids and emulsions, as well as microbes, fungi and viruses, are also removed by the present system. See Lotts “Where Oxidation Reduction Media Work, Here are Five Ways to Use Them”, incorporated herein by reference, regarding the uses of redox reactions. The granular copper media of the present invention having a particle size of greater than about 100 mesh has been found to be particularly suited for the removal of multi-phase inorganic contaminants in high flow, high volume applications.

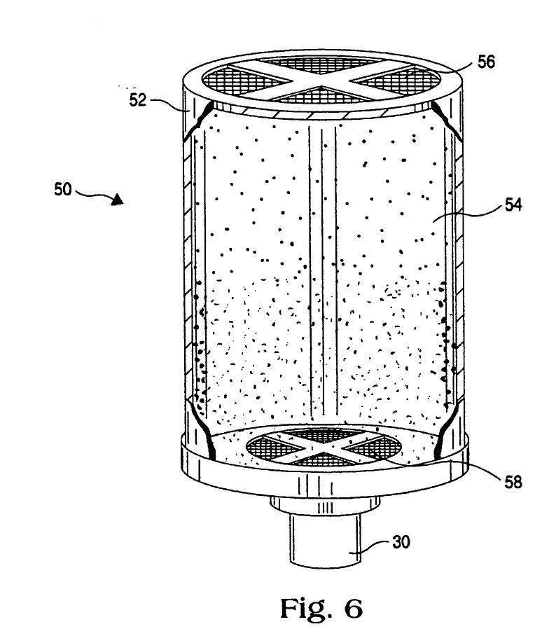

In an alternative preferred embodiment of the inner filter, as shown in FIG. 6, the inner filter 50 includes a uniform region 54 of copper granules entirely fills the inner filter housing 52 and is situated and extends between, in a homogeneous manner, the stainless steel mesh inlet 56 and the stainless steel mesh outlet 58. As shown in FIG. 6, the alternative embodiment may not utilize the filter pad. However, it should be known that the alternative embodiment may use the filter pad in a manner similar to that shown in FIG. 4.

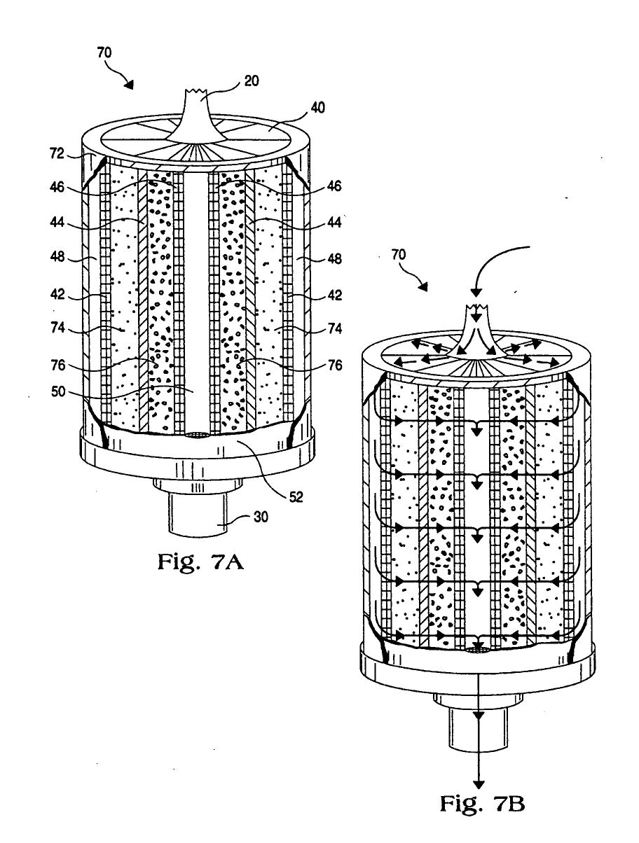

In another preferred embodiment of the inner filter, illustrated in FIG. 7A and FIG. 7B, the inner filter 70 is configured for radial inward flow of the water to be processed. The water entering inlet 20 of filter 70 and into the inner filter housing 72 first contacts a first cap 40, which is connected to and abuts an axial mesh inlet 42, the uniform region 74, an axially oriented filter pad 44, the region of GAC 76, and axial mesh outlet 46 to form a fluid-tight seal about the top portion of the inner filter housing 72 to channel the incoming water within a radial space 48 which surrounds the inner filter housing 72.

Axial mesh inlet 42 and axial mesh outlet 46 are similar to mesh inlet 26 and mesh outlet 28 described above. A second cap 52 seals all of bottom portion of the inner filter housing 72 except a core 50 to seal the radial space 48 thereby requiring the water to flow through the uniform region 74 of copper, the axially oriented filer pad 44, and the region of GAC 76 and into the core 50. Core 50 corresponds with and is in fluid communication with the outlet 30 to allow filtered water to flow out of filter 70. First cap 40 and second cap 52 can be made of plastic, stainless steel or any other suitable material. The second cap 52 is solidably configured to block water flow out of the second cap 52. Thus, the water radially flows from the radial space 48 through holes positioned on the core 50.

As illustrated in FIG. 7A, uniform region 74 and region of GAC 76 are uniformly dispersed between the first cap 40 and the second cap 52 with the axially oriented filter pad 44 separating the two. The axial mesh inlet 42 separates the uniform region 74 of copper media from the radial space 48, and the axial mesh outlet 46 separates region of GAC 76 from core 50.

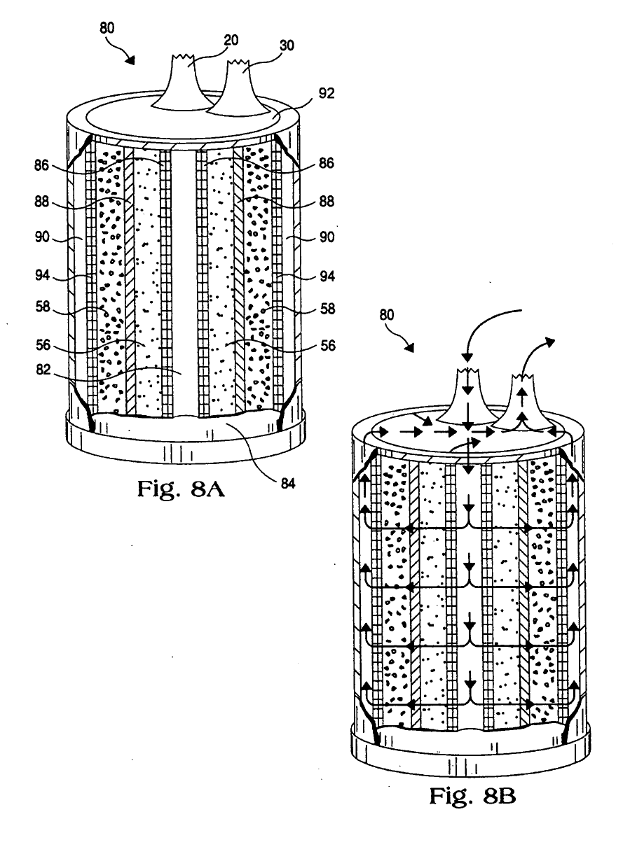

In another preferred embodiment of the inner filter 80, a reverse flow configuration, illustrated in FIG. 8A and FIG. 8B, which is also a cylindrical type filter, may be employed whereby the core 82 separates the inner filter 80 into inner and outer sections 56 and 58, respectively. The core 82, which is plastic or other non-reactive material, has a gap or holes so that the water may flow from the inner section 56 to the outer section 58.

As shown in FIG. 8B, the water to be processed enters the inlet 20 and flows through the core 82. The second cap 84 is configured to radially direct the water through the axial mesh inlet 86 and into the inner section 56. The inner section is filled with a uniform region of copper. The water then flows from the inner section 56 through an axially oriented filter pad 88 and the outer section 58. The outer section 58 comprises a region of GAC. The water then passes through axial mesh outlet 94 into the radial space 90. The radial space 90 is configured to direct the flow out of the outlet 30 preferably located at the first cap 92. Thus, the flow of water in the radial space 90 is in the reverse direction of the flow of water in the core.

Testing has shown that known filters in the art, such as the KDF filter media, have not met standards for use in high velocity flow type applications. The KDF filter media is a copper-zinc reduction/oxidation media that has been shown by testing to reduce chlorine, as well as other contaminants in tap water. KDF filter media remove or reduce chlorine and contaminants from water because of the electrical and catalytic potential of the reduction-oxidation (redox) reaction.

Testing, however, revealed that the KDF type 55 did not effectively remove chlorine from the tap water at a city water source that was treated with aluminum sulfate. Further investigation revealed that the aluminum sulfate treated water has a deleterious effect on the action of the KDF filter in reducing chlorine.

The present invention operates efficiently for the aluminum sulfate treated test water. Actual tests were applied in configurations containing both KDF type 55 (a copper-zinc alloy) and KDF/10° C. (a combination of a copper-zinc alloy and pure copper) and other filter configurations containing 100% copper. Testing demonstrated that the test sample results with the filter system of the present invention were dramatically superior to the early test sample results where only KDF type 55 was used, and the later tests where both KDF type 55 and KDF/100C were used. For example, the KDF type 55 filter failed at 400 gallons, i.e. chlorine breakthrough occurred at low (less than 50%) chlorine reduction levels. The embodiment of the present invention containing 100% copper was effective at reducing the chlorine levels by greater than 90%, even beyond 4000 gallons. These test results demonstrated that the 100% copper of the present invention was superior in reducing chlorine for the specified capacity of 4000 gallons, while maximizing the water flow through the test filter.

A review of the test data for the 100% copper filter of the present invention, and KDF/100C, indicates that the 100% copper filter of the present invention has a reduction rate of 93.2% at a flow rate of 2.3 gpm after 4225 gallons, as compared to the KDF/100C reduction rate of 86.5% at a flow rate of 1.2 gpm. These results clearly indicate that the 100% copper filter of the present invention was superior in performance to the KDF/100C configuration, and the KDF type 55 configuration.

A summary of the specific test data follows:

| Copper 100 C of the present | | | | | | | | |
|---|---|---|---|---|---|---|---|---|
| invention | | | KDF/100 C | | | KDF55 | | |
| Gallons | Flow | Reduction | Gallons | Flow | Reduction | Gallons | Flow | Reduction |

| | | | | | | |
|---|---|---|---|---|---|---|
| 422.5 | 2.3 gpm | 93.2% | 422.5 | 1.2 gpm | 86.5% | Test discontinued at 400 |

| | | |
|---|---|---|
| Average Reduction = 94.4% | Average Reduction = 91.4% | gallons due to poor results |

Referring to FIG. 3 and FIG. 4, the present invention further comprises a method for removing contaminants from water comprising passing the water through the filter 10 comprising the outer housing 22 and the inner filter housing 24. Next, the water is dispersed through the uniform region 34 of copper medium disposed within the inner filter housing 24. The contaminants are next removed from the water by bonding the contaminants to the uniform region 34 of copper medium. Simultaneously, organisms are removed from the water by reacting the organisms in an oxidation/reduction reaction with the uniform region 34 of copper medium.

The method further comprises passing the water through the filter pad 36 secured within the inner filter housing 24 in fluid communication with the uniform region 34 of copper medium. Next, the water is dispersed through the region of GAC 38 secured within the inner filter housing 24 in fluid communication with the filter pad 36. The water is then exited out of the filter housing 24 through the outlet 30.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

1. A water filter device containing copper media comprising:
(a) an outer housing comprising an inlet and an outlet; and
(b) an inner filter comprising an inner filter housing, an inner filter housing inlet at one end, an inner filter housing outlet at an opposing end, and at least one uniform region of substantially pure copper media disposed within said inner filter housing; wherein said inner filter is situated within and in fluid communication with said outer housing; and said inner filter housing inlet is in fluid communication with said inlet and said inner filter housing outlet is in fluid communication with said outlet.

2. The water filter device of claim 1, wherein said substantially pure copper media contains about 90% to about 100% of copper.

3. The water filter device of claim 2, wherein said substantially pure copper media has a particle size from about 40 to about 200 mesh and a density of from about 3.5 to about 5.0 grams per cubic centimeter.

4. The water filter device of claim 3, wherein said particle size of said substantially pure copper media is about 120 mesh.

5. The water filter device of claim 1, wherein said at least one uniform region of substantially pure copper media is disposed from said inner filter housing inlet downward, extending at least about one-half of said inner filter housing.

6. The water filter device of claim 5 further comprising a region of granulated activated carbon.

7. The water filter device of claim 6, wherein said granulated activated carbon has a particle size of from about 10 mesh to about 100 mesh.

8. The water filter device of claim 6, wherein said water filter device further comprises a filter pad disposed between said region of said granulated activated carbon and said at least one uniform region of substantially pure copper media.

9. The water filter device of claim 8, wherein said filter pad is one selected from said group consisting of a polymeric pad, and a polypropylene pad.

10. The water filter device of claim 5, wherein said water filter device further comprises a mesh inlet disposed at said inner filter housing inlet, and a mesh outlet disposed at said inner filter housing outlet.

11. The water filter device of claim 1, wherein the water filter device is a shower filter.

12. A method of removing chlorine from water using a substantially pure copper media, said method comprising the steps of:
(a) providing said water filter device of claim 1;
(b) entering a water containing chlorine into said inlet of said outer housing;
(c) passing said water through said at least one uniform region of substantially pure copper media disposed within said inner filter; wherein said substantially pure copper media substantially removes said chlorine in said water;
(d) exiting filtered water obtained from step (c) from said outlet of said outer housing for use.

13. The method of claim 12, wherein said water filter device removes at least about 90% of the chlorine when said water passes through said water filter device at a rate of about 2.3 gallons per minute.

14. The method of claim 13, wherein said water is sulfated water.

15. A water filter device containing copper media comprising:
(i) an outer housing comprising an inlet and an outlet; and
(ii) an inner filter comprising:
(a) an inner filter housing having a first cap disposed at an upper end of said inner filter housing; a second cap disposed at a lower end of said inner filter housing; an inner filter housing inlet disposed on said first cap and in fluid communication with said inlet of said outer housing; and an inner filter housing outlet disposed on said second cap and in fluid communication with said outlet of said outer housing;
(b) a region of granulated activated carbon disposed between said first and second caps, said region of granulated activated carbon being axially around a core; said core being in fluid communication with said inner filter housing outlet on said second cap;
(c) an uniform region of substantially pure copper media disposed between said first and second caps, axially around said region of granulated activated carbon;
(d) a filter pad disposed axially between said region of granulated activated carbon and said uniform region of substantially pure copper media;
(e) an axial mesh inlet disposed around external of said uniform region of substantially pure copper media;
(f) a radial space between said first and second caps, external of said axial mesh inlet; said radial space being in fluid communication with said inner filter housing inlet on said first cap; and
(g) an axial mesh outlet disposes around internal of said region of granulated activated carbon.

16. The water filter device of claim 15, wherein said substantially pure copper media contains about 90% to about 100% of copper.

17. The water filter device of claim 16, wherein said substantially pure copper media has a particle size from about 40 to about 200 mesh and a density of from about 3.5 to about 5.0 grams per cubic centimeter.

18. The water filter device of claim 17, wherein said particle size of said substantially pure copper media is about 120 mesh.

19. A method of removing chlorine from water using a substantially pure copper media, said method comprising the steps of:
(a) providing said water filter device of claim 15;
(b) entering a water containing chlorine into said inlet of said outer housing;
(c) passing said water through said inner filter housing inlet; to said radial space, through said uniform region of substantially pure copper media, through said filter pad, through said region of granulated activated carbon, to said core; wherein said substantially pure copper media substantially removes said chlorine in said water;
(d) exiting filtered water obtained from step (c) from said outlet of said outer housing for use.

20. The method of claim 19, wherein said water filter device removes at least about 90% of the chlorine when said water passes through said water filter device at a rate of about 2.3 gallons per minute.

21. The method of claim 20, wherein said water is sulfated water.

22. A water filter device containing copper media comprising:
(i) an outer housing comprising an inlet and an outlet; and
(ii) an inner filter comprising:
(a) an inner filter housing having a first cap disposed at an upper end of said inner filter housing; a second cap disposed at a lower end of said inner filter housing; an inner filter housing inlet and an inner filter housing outlet disposed on said first cap, said inner filter housing inlet being in fluid communication with said inlet of said outer housing; and said inner filter housing outlet being in fluid communication with said outlet of said outer housing;
(b) an uniform region of substantially pure copper media disposed between said first and second caps, and being axially around a core; said core being in fluid communication with said inner filter housing inlet on said first cap;
(c) a region of granulated activated carbon disposed between said first and second caps, and being axially around said uniform region of substantially pure copper media;
(d) a filter pad disposed axially between said region of granulated activated carbon and said uniform region of substantially pure copper media;
(e) an axial mesh inlet disposes around internal of said uniform region of substantially pure copper media;
(f) an axial mesh outlet disposed around external of said region of granulated activated carbon; and
(g) a radial space between said first and second caps, external of said axial mesh outlet; said radial space being in fluid communication with said inner filter housing outlet on said first cap.

23. The water filter device of claim 22, wherein said substantially pure copper media contains about 90% to about 100% of copper.

24. The water filter device of claim 23, wherein said substantially pure copper media has a particle size from about 40 to about 200 mesh and a density of from about 3.5 to about 5.0 grams per cubic centimeter.

25. The water filter device of claim 24, wherein said particle size of said substantially pure copper media is about 120 mesh.

25. A method of removing chlorine from water using a substantially pure copper media, said method comprising the steps of:
(a) providing said water filter device of claim 22;
(b) entering a water containing chlorine into said inlet of said outer housing;
(c) passing said water through said inner filter housing inlet; to said core, through said uniform region of substantially pure copper media, through said filter pad, through said region of granulated activated carbon, to said radial space; wherein said substantially pure copper media substantially removes said chlorine in said water;
(d) exiting filtered water obtained from step (c) from said outlet of said outer housing for use.

26. The method of claim 25, wherein said water filter device removes at least about 90% of the chlorine when said water passes through said water filter device at a rate of about 2.3 gallons per minute.

27. The method of claim 26, wherein said water is sulfated water.
